(19) United States
(12) Patent Application Publication
(10) Pub. No.: US 2007/0242754 A1
(43) Pub. Date: Oct. 18, 2007

(54) Apparatus for processing data stream for digital broadcasting system and method thereof

(75) Inventors: Jung-pil Yu, Suwon-si (KR); Yong-sik Kwon, Seoul (KR); Eui-Jun Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/505,369

(22) Filed: Aug. 17, 2006

Related U.S. Application Data
(60) Provisional application No. 60/788,707, filed on Apr. 4, 2006.
(60) Provisional application No. 60/814,910, filed on Jun. 20, 2006.

(30) Foreign Application Priority Data
Jul. 13, 2006 (KR) 2006-65752

(51) Int. Cl. H04N 11/02

(52) U.S. Cl. 375/240.26

(57) ABSTRACT

An apparatus for processing data for a digital broadcasting system, the digital broadcasting system including an interleaver, includes a data extractor that receives a data stream from the interleaver and extracts specified data from the data stream to obtain extracted data, a data processor that processes the extracted data according to a specified data process to obtain processed data, and a data stuffer that reconstructs the data stream by inserting the processed data into a portion of the data stream from which the specified data was extracted.

### CROSS-REFERENCE TO RELATED APPLICATIONS

This application claims the benefit of U.S. Provisional Patent Applications No. 60/788,707 filed on Apr. 4, 2006, and No. 60/814,910 filed on Jun. 20, 2006, in the United States Patent and Trademark Office, and Korean Patent Application No. 2006-65752 filed on Jul. 13, 2006, in the Korean Intellectual Property Office. The disclosures of these three priority applications are incorporated herein by reference in their entirety.

### BACKGROUND OF THE INVENTION

1. Field of the Invention

An aspect of the invention relates to an apparatus for processing a data stream for a digital broadcasting system and a method thereof, and more particularly to an apparatus for processing a data stream for a digital broadcasting system and a method thereof that can process a part of the data stream and then reconstruct the data stream by extracting and processing a part of a data stream to obtain processed data and then inserting the processed data into a portion of the data stream from which the part of the data stream was extracted to improve the data processing efficiency of an Advanced Television Systems Committee (ATSC) Vestigial Sideband (VSB) Digital Television (DTV) system that is an American-type digital terrestrial broadcasting system.

2. Description of the Related Art

An ATSC VSB DTV system that is an American-type digital terrestrial broadcasting system is a single-carrier system, and provides a field sync signal for each unit of 312 data segments. Accordingly, this system exhibits poor reception performance in an inferior channel, particularly in a Doppler fading channel.

FIG. 1 is a block diagram of a digital broadcast transmitter complying with an ATSC VSB DTV standard that is an American-type digital terrestrial broadcasting system. The current version of this standard is ATSC Digital Television Standard A/53, Revision E, dated Dec. 27, 2005, with Amendment No. 1, dated Apr. 18, 2006, and can be downloaded from www.atsc.org. This standard is referred to hereafter as ATSC Standard A/53E. The contents of this standard are incorporated herein by reference in their entirety.

The digital broadcast transmitter of FIG. 1 includes a randomizer 110 randomizing a transport stream, a Reed-Solomon (RS) encoder 120 in the form of a concatenated encoder that adds parity bytes to the transport stream in order to correct errors occurring due to channel characteristics in a transmission process, an interleaver 130 interleaving the RS-encoded data according to a specified interleaving pattern, and a 2/3-rate trellis encoder 140 mapping the interleaved data into 8-level data symbols by performing a 2/3-rate trellis encoding of the interleaved data. The transport stream received by the randomizer 110 is an MPEG-2 transport stream, and thus the digital broadcast transmitter of FIG. 1 performs an error correction encoding of the MPEG-2 transport stream. The digital broadcast transmitter of FIG. 1 is an 8-VSB system because the trellis encoder 140 maps the interleaved data into 8-level data symbols.

The digital broadcast transmitter further includes a multiplexer (MUX) 150 multiplexing a field sync signal and a segment sync signal with the data symbols from the trellis encoder 140 to obtain a ATSC VSB DTV data frame having the configuration shown in FIG. 2, a VSB modulator 160 inserting a pilot into the data symbols which have been multiplexed with the segment sync signal and the field sync signal by adding a specified DC value to the data symbols, and performing a VSB modulation of the data symbols by pulse-shaping the data symbols, and an RF converter 170 up-converting the VSB-modulated signal into an RF channel band signal which is then transmitted.

In the digital broadcast transmitter, the MPEG-2 transport stream is randomized by the randomizer 110, outer-encoded by the RS encoder 120 serving as an outer encoder, and then distributed by the interleaver 130. The interleaved data is inner-encoded in units of 12 symbols and then mapped into 8-level data symbols by the trellis encoder 140. After the field sync signal and the segment sync signal are multiplexed with the data symbols by the multiplexer 150, a pilot is inserted into the data symbols, the data symbols are VSB-modulated by the VSB modulator 160, and the modulated data is converted into the RF channel band signal by the RF converter 170.

A digital broadcast receiver (not shown) down-converts the RF signal into a baseband signal, demodulates and equalizes the baseband signal, and then channel-decodes the demodulated signal to restore the original signal.

FIG. 2 shows an ATSC VSB DTV data frame used in the American-type digital broadcasting system into which a segment sync signal and a field sync signal are inserted. As shown in FIG. 2, one frame is composed of two fields, and one field is composed of one field sync segment as the first segment and 312 data segments. Also, one data segment in the ATSC VSB DTV data frame corresponds to one MPEG-2 packet, and is composed of a segment sync signal of four symbols and 828 data symbols.

In FIG. 2, the segment sync signal and the field sync signal are used for synchronization and equalization in the digital broadcast receiver. That is, the field sync signal and the segment sync signal are known data known to both the digital broadcast transmitter and the digital broadcast receiver, which is used as a reference signal when the equalization is performed in the digital broadcast receiver.

In order to improve the drawbacks of the existing ATSC VSB DTV system of FIG. 1, a system for forming and transmitting a dual transport stream produced by adding a turbo stream to a normal stream of the existing American-type digital broadcasting system has been proposed.

Accordingly, a method of effectively processing a dual transport stream in the digital broadcast transmitter is required.

### SUMMARY OF THE INVENTION

An aspect of the invention has been developed in order to solve the above drawbacks and other problems associated with the conventional arrangement. An aspect of the invention is to provide an apparatus for processing a data stream for a digital broadcasting system and a method thereof that can process a part of the data stream and then reconstruct the data stream by extracting and processing a part of a data stream to obtain processed data and then inserting the processed data into a portion of the data stream from which the part of the data stream was extracted to improve the data processing efficiency of an ATSC VSB DTV system that is an American-type digital terrestrial broadcasting system.

In accordance with an aspect of the invention, there is provided an apparatus for processing data in a digital broadcasting system, the digital broadcasting system comprising an interleaver, the apparatus including a data extractor that receives a data stream from the interleaver and extracts specified data from the data stream to obtain extracted data, a data processor that processes the extracted data according to a specified data process to obtain processed data, and a data stuffer that reconstructs the data stream by inserting the processed data into a portion of the data stream from which the specified data was extracted.

The data stream may be a dual transport stream comprising a normal stream and a turbo stream.

The data extractor may extract the turbo stream from the dual transport stream as the specified data to obtain the extracted data.

The turbo stream may include a parity insertion region, and the data processor may include an outer encoder that encodes the turbo stream to obtain parity data and inserts the parity data into the parity insertion region of the turbo stream to obtain an encoded turbo stream, and an outer interleaver that interleaves the encoded turbo stream to obtain an interleaved turbo stream.

The data stuffer may reconstruct the dual transport stream by inserting the interleaved turbo stream into the portion of the dual transport stream from which the turbo stream was extracted as the specified data.

In accordance with another aspect of the invention, there is provided a method of processing data for a digital broadcast transmission, the method including receiving a data stream on which an interleaving process has been performed and extracting specified data from the data stream to obtain extracted data, performing a specified data process on the extracted data to obtain processed data, and reconstructing the data stream by inserting the processed data into a portion of the data stream from which the specified data was extracted.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of embodiments of the invention, taken in conjunction with the accompanying drawings of which:

FIG. 1 is a block diagram of a conventional digital broadcast (ATSC VSB DTV) transmitter;

FIG. 2 is a diagram of a conventional ATSC VSB DTV data frame;

FIG. 3 is a block diagram of an example of a system for transmitting a digital broadcasting signal that is provided with a data processing apparatus according to an aspect of the invention;

FIG. 4 is a block diagram of an example of the data processing apparatus of FIG. 3 according to an aspect of the invention;

FIG. 5 is a diagram for explaining an example of an encoding process performed by the outer encoder of FIG. 4 according to an aspect of the invention;

FIG. 6 is a diagram for explaining an example of an interleaving process performed by outer interleaver of FIG. 4 according to an aspect of the invention;

FIG. 7 is a flowchart of an example of a method of processing data according to an aspect of the invention; and

FIG. 8 is a flowchart of an example of a method of processing data according to an aspect of the invention applied to a dual transport stream.

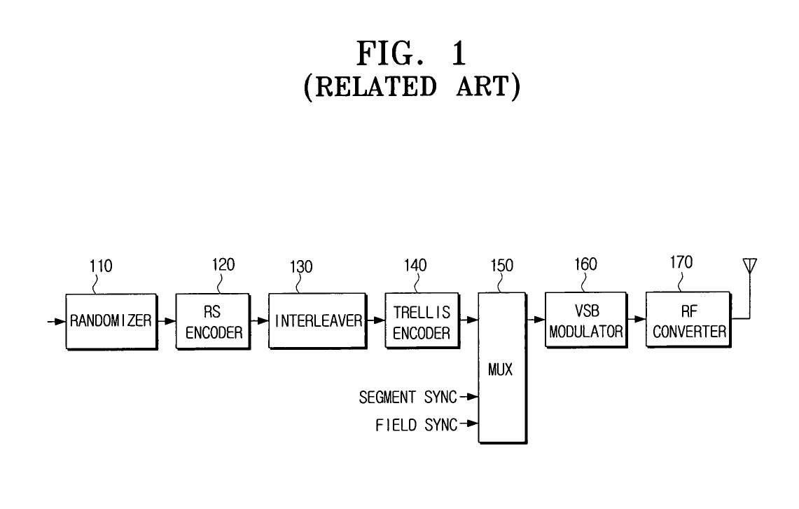

### DETAILED DESCRIPTION OF THE EMBODIMENTS

Reference will now be made in detail to embodiments of the invention, examples of which are shown in the accompanying drawings, wherein like reference numerals refer to like elements throughout. The specific configurations and elements in the following description are merely examples provided to assist in a comprehensive understanding of the invention. Thus, it is apparent that the invention can be carried out without these specific configurations and elements. Also, well-known functions and elements are not described in detail to avoid obscuring aspects of the invention with unnecessary details.

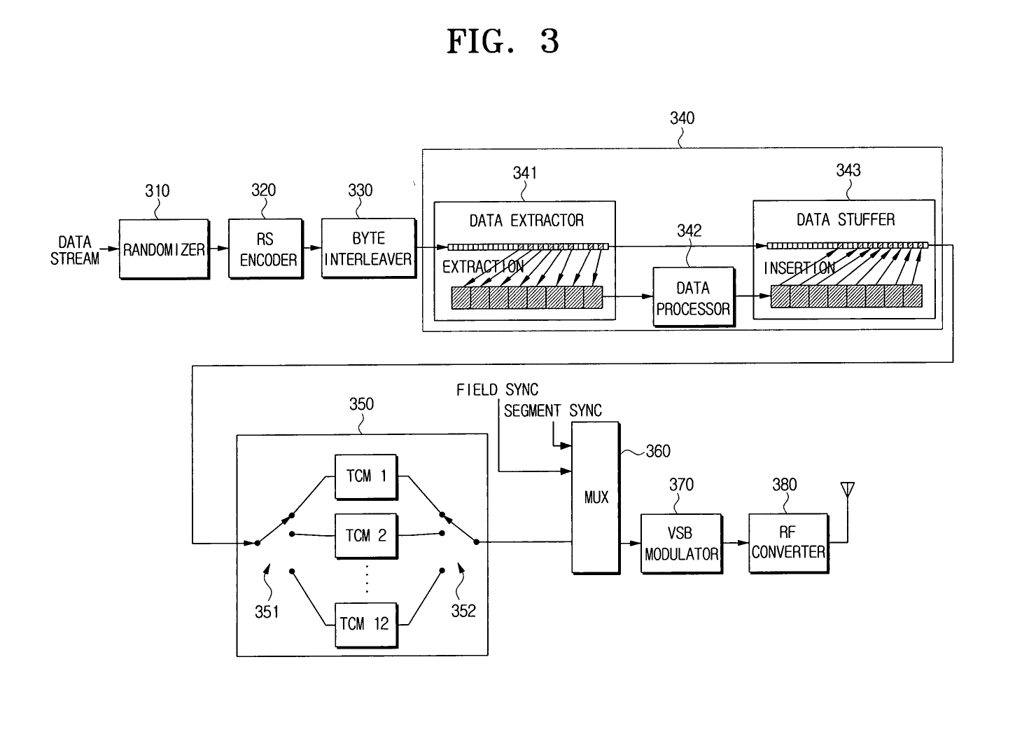

FIG. 3 is a block diagram of an example of a system for transmitting a digital broadcasting signal that is provided with a data processing apparatus according to an aspect of the invention. Referring to FIG. 3, the system for transmitting a digital broadcasting signal includes a randomizer 310, an RS encoder 320, a byte interleaver 330, a data processing apparatus 340, a trellis encoder 350, a multiplexer (MUX) 360, a VSB modulator 370, and an RF converter 380.

The randomizer 310 randomizes an input data stream to make more effective use of an allocated channel space.

The RS encoder 320 adds parity bytes to the data stream by performing an RS encoding on the data stream to enable errors occurring due to variations and disturbances in a channel to be corrected.

The interleaver 330 interleaves the encoded data stream according to a specified interleaving pattern.

The data processing apparatus 340 according to an aspect of the invention performs a specified data process on the interleaved data stream. The data processing apparatus 340 includes a data extractor 341, a data processor 342, and a data stuffer 343.

The data extractor 341 extracts a part of the data stream interleaved by the byte interleaver 330. The data processor 342 performs a specified data process on the extracted data. The data stuffer 343 inserts the data processed by the data processor 342 into the portion of the data stream from which the data was extracted by the data extractor 341. In FIG. 3, the operation of the data processing apparatus 340 in which data is extracted from the data stream, the extracted data is processed, and then the processed data is inserted into the portion of the data stream from which the data is extracted, is merely exemplified. The detailed construction and operation of the data processing apparatus 340 according to an aspect of the invention will be explained later.

The trellis encoder 350 trellis-encodes the data stream processed by the data processing apparatus 340. The trellis encoder 350 includes a twelve trellis encoding units TCM1 to TCM12, a splitter 351, and a de-splitter 352. The splitter 351 successively outputs the data stream outputted from the data processing apparatus 340 to the trellis encoding units TCM1 to TCM12 in byte units. That is, the splitter 351 outputs one byte of the data stream outputted from the data processing apparatus 340 to the trellis encoding unit TCM1, then outputs the next byte of the data stream outputted from the data processing apparatus 340 to the trellis encoding unit TCM2, and so forth, until after twelve bytes, the splitter 350 again outputs one byte of the data stream outputted from the data processing apparatus 340 to the trellis encoding unit TCM1. The trellis encoding units TCM1 to TCM12 trellis-encode the input data stream from the splitter 351. The input data stream from the splitter 351 contains 8-bit bytes of input data. Each of the trellis encoding units TCM1 to TCM12 encodes one 8-bit byte of input data from the input data stream from the splitter 351 as four 2-bit words, and successively outputs one 3-bit data symbol for each of these four 2-bit words, with a 12-symbol delay between each of the data symbols, thereby outputting four data symbols for each byte of input data. The de-splitter 352 successively outputs the data symbols from the trellis encoding units TCM1 to TCM12 to the multiplexer 360 at 1-symbol intervals. That is, the de-splitter 352 outputs one data symbol from the trellis encoding unit TCM1, then after a 1-symbol interval outputs one data symbol from the trellis encoding unit TCM2, and so forth, until after a 12-symbol interval, the de-splitter 352 again outputs one data symbol from the trellis encoding unit TCM1. The operation of the splitter 351 and the de-splitter 352 of the trellis encoder 350 are the same as the operation of the splitter and the de-splitter of the trellis encoder described in Section 5.4.1.4 of ATSC Standard A/53E referred to above, and thus will not be described in detail here.

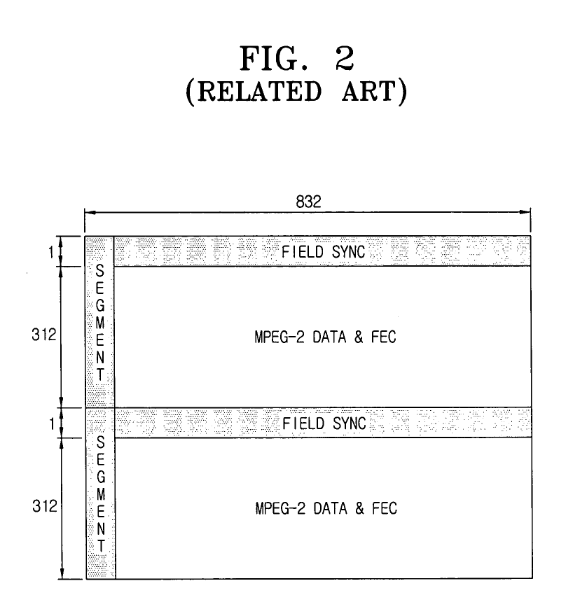

The multiplexer 360 multiplexes the data symbols from the trellis encoder 350 with a segment sync signal and a field sync signal to produce a VSB data frame having the same configuration as the ATSC VSB DTV frame shown in FIG. 2, except that the contents of the data segments in the VSB frame produced by the multiplexer 360 according to an aspect of the invention are different from the contents of the data segments in the ATSC VSB DTV frame in the prior art.

The VSB modulator 370 inserts a pilot into the data symbols which have been multiplexed with the segment sync signal and the field sync signal by adding a specified DC value to the data symbols, and performs VSB modulation by pulse-shaping the data symbols. The RF converter 380 up-converts the VSB-modulated transport stream into an RF channel band signal which is then transmitted.

As described above, the data processing apparatus 340 extracts and processes only a part of the entire data stream interleaved by the byte interleaver 330, and then inserts the processed data into the portion of the data stream from which the data was extracted to reconstruct the data stream when the data stream is processed between the byte interleaver 330 and the splitter 351 of the trellis encoder 350. The data processing apparatus 340 according to an aspect of the invention will now be explained.

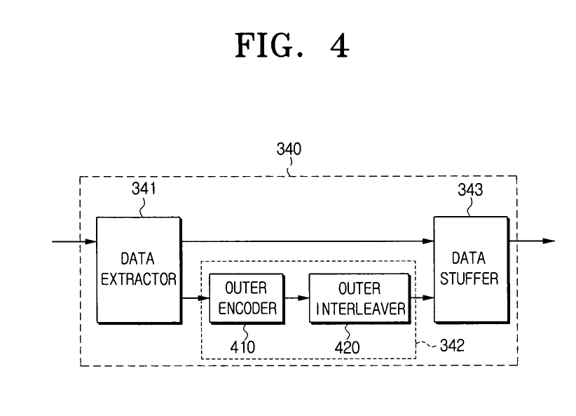

FIG. 4 is a block diagram of an example of the data processing apparatus 340 according to an aspect of the invention applied to a digital broadcast transmitter forming and transmitting a dual transport stream including a normal stream and a turbo stream. According to an aspect of the invention, a turbo stream is a data stream that is compressed according to a specified compression standard and is subjected to a robust data process by encoding the compressed data using turbo codes to provide improved reception performance in an inferior channel, particularly in a Doppler fading channel. However, the invention is not limited to encoding the compressed data using turbo codes, and the compressed data may be encoded using other types of codes. Turbo stream packets may be inserted at one or more specified positions in the dual transport stream. Specifically, the dual transport stream may be constructed so that turbo stream packets are inserted in one or more specified data segments among the 312 data segments constituting one field, and normal stream packets are inserted in the remaining data segments of the field. Also, the dual transport stream may be constructed so that turbo stream packets are inserted into an MPEG-2 transport stream adaptation field provided in one or more data segments carrying normal stream packets. A parity insertion region is provided in each byte of the turbo stream.

The data processing apparatus 340 of FIG. 4 includes a data extractor 341, an outer encoder 410, an outer interleaver 420, and a data stuffer 343.

The data extractor 341 extracts only the turbo stream from the dual transport stream. That is, the data extractor 341 extracts data from the dual transport stream only at the specified positions at which the turbo stream packets are inserted in the dual transport stream. The data extractor 341 may be implemented by a demultiplexer.

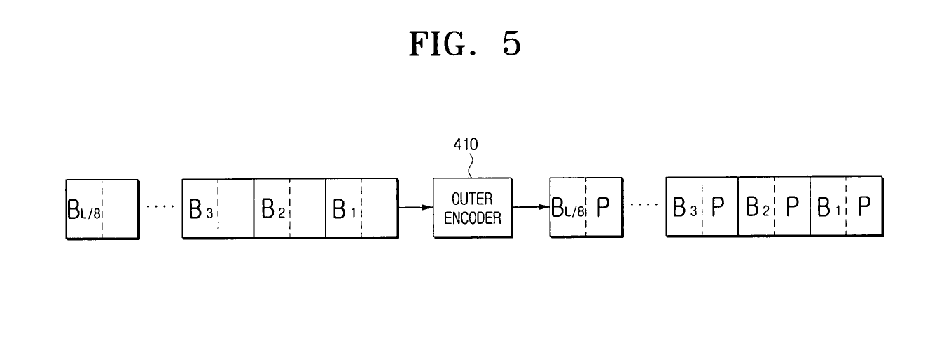

The outer encoder 410 encodes only the turbo stream extracted from the dual transport stream by the data extractor 341. FIG. 5 is a diagram for explaining an example of an encoding process performed by the outer encoder 410 according to an aspect of the invention. As shown in FIG. 5, the outer encoder 410 receives and encodes the turbo stream data extracted by the data extractor 341 in byte units, and outputs the encoded turbo stream data in byte units. As shown in FIG. 5, the outer encoder 410 processes the turbo data stream in blocks of L bits, where the first byte encoded in a block is byte B1, the second byte encoded in a block is byte B2, the third byte encoded in a block is byte B3, and the last byte encoded in a block is byte BL/8. The outer encoder 410 generates parity data P for each byte of the extracted turbo stream, and inserts the generated parity data P into the parity insertion region provided in each byte of the turbo stream as shown in FIG. 5. The parity insertion region shown in FIG. 5 is merely a conceptual representation and is not intended to indicate the actual position of the parity insertion region within the byte. The parity insertion region can be provided at any suitable place in the byte, and can either be a continuous region or a segmented region, i.e., a region comprising two or more non-contiguous segments.

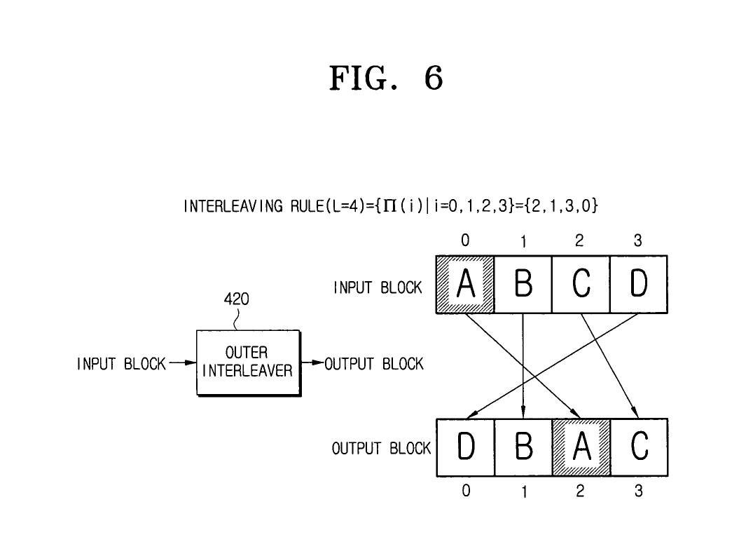

The outer interleaver 420 interleaves the bits of the encoded turbo stream from the outer encoder 410. FIG. 6 is a diagram for explaining an example of an interleaving process performed by the outer interleaver 420 according to an aspect of the invention. Referring to FIG. 6, the outer interleaver 420 interleaves the bits of the encoded turbo stream from the outer encoder 410 according to a specified interleaving rule. For example, if the interleaving rule is {2, 1, 3, 0} and bits ABCD of the encoded turbo stream are successively inputted to the outer interleaver 420, the outer interleaver 420 interleaves these bits ABCD and outputs them in the order DBAC as shown in FIG. 6 as an interleaved turbo stream. However, the invention is not limited to the interleaving rule of {2, 1, 3, 0} which is merely one example of an interleaving rule, and any suitable interleaving rule may be used.

The data stuffer 343 reconstructs the dual transport stream by inserting the interleaved turbo stream into the portions of the dual transport stream from which the data extractor 341 extracted the turbo stream.

The encoding process performed by the outer encoder 410 and the interleaving process performed by the outer interleaver 420 are part of a robust data process that enables the turbo stream of the dual transport stream to be transmitted without errors over an inferior channel, such as a Doppler fading channel, over which the normal stream of the dual transport stream cannot be transmitted without errors. Also, the robust data process enables the turbo stream to be transmitted with an error rate that is lower than an error rate when the turbo stream is transmitted without being subjected to the robust data process. The robust data process may also include other processes. The normal transport stream may comply with the ATSC VSB DTV standard. However, any other type of suitable stream may be used as the normal stream.

In accordance with an aspect of the invention, the data processing apparatus extracts only the turbo stream from the interleaved dual transport stream, and then performs a robust data process on the extracted turbo stream by encoding and interleaving the turbo stream. Then, the apparatus reconstructs the dual transport stream by inserting the robust data processed turbo stream into the portions of the dual transport stream from which the turbo stream was extracted.

Accordingly, the data processing apparatus according to an aspect of the invention can perform the robust data process only on the turbo stream, thereby avoiding the necessity of processing the entire dual transport stream to perform the robust data process on the turbo stream.

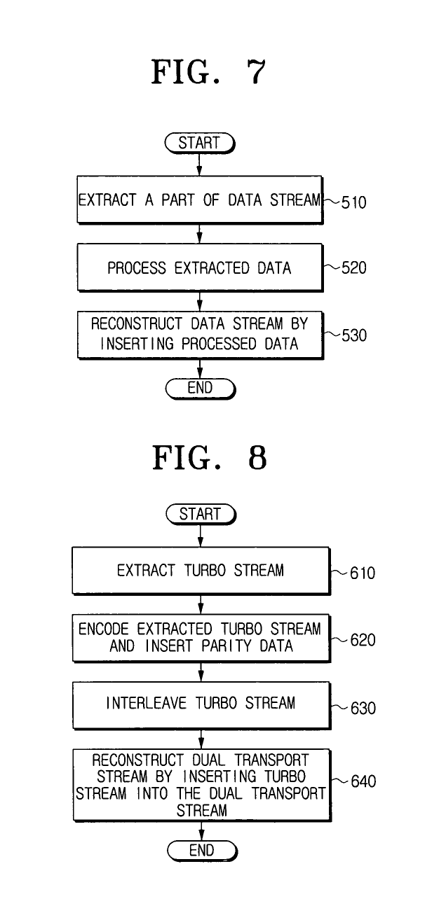

FIG. 7 is a flowchart of an example of a method of processing data according to an aspect of the invention.

Referring to FIG. 7, a part of the data stream outputted from the byte interleaver 330 is extracted (block 510). A specified data process is performed on the extracted data (block 520). The processed data is inserted into the portion of the data stream from which the data was extracted in the block 510 to reconstruct the data stream (block 530).

FIG. 8 is a flowchart of an example of a method of processing data according to an aspect of the invention applied to a digital broadcast transmitter that transmits a dual transport stream including a normal stream and a turbo stream. The normal stream may comply with the ATSC VSB DTV standard. However, any other type of suitable stream may be used as the normal stream.

Referring to FIG. 8, the turbo stream is extracted from the dual transport stream that includes the normal stream and the turbo stream (block 610). Parity data is generated by encoding the extracted turbo stream, and the generated parity data is inserted into the parity insertion region in the turbo stream (block 620). The encoded turbo stream is interleaved according to the specified interleaving rule (block 630). The interleaved turbo stream is inserted into the portion of the dual transport stream from which the turbo stream was extracted in the block 610 to reconstruct the dual transport stream (block 640).

As described above, according to an aspect of the invention, the data processing efficiency of the digital broadcast transmitter is increased by processing only a part of the entire data stream in the ATSC VSB DTV system that is an American-type digital terrestrial broadcasting system. Also, by applying an aspect of the invention to a digital broadcast transmitter that transmits the dual transport stream including the normal stream and the turbo stream, a robust data processing is performed only on the turbo stream, and thus the data processing efficiency of the digital broadcast transmitter can be increased.

Although an aspect of the invention has been described above in terms of performing a robust data process on a turbo stream of a dual transport stream, the invention is not limited to such an implementation, and any other suitable type of data process may be performed on the turbo stream. Furthermore, instead of the turbo stream, the dual transport stream may include any other suitable type of stream in addition to the normal stream, and a robust data process or any other suitable type of data process may be performed on the other type of stream.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. An apparatus for processing data in a digital broadcasting system, the digital broadcasting system comprising an interleaver, the apparatus comprising:
a data extractor that receives a data stream from the interleaver and extracts specified data from the data stream to obtain extracted data;
a data processor that processes the extracted data according to a specified data process to obtain processed data; and
a data stuffer that reconstructs the data stream by inserting the processed data into a portion of the data stream from which the specified data was extracted.

2. The apparatus of claim 1, wherein the data stream is a dual transport stream comprising a normal stream and a turbo stream.

3. The apparatus of claim 2, wherein the data extractor extracts the turbo stream from the dual transport stream as the specified data to obtain the extracted data.

4. The apparatus of claim 3, wherein the turbo stream comprises a parity insertion region; and
wherein the data processor comprises:
an outer encoder that encodes the turbo stream to obtain parity data and inserts the parity data into the parity insertion region of the turbo stream to obtain an encoded turbo stream; and
an outer interleaver that interleaves the encoded turbo stream to obtain an interleaved turbo stream.

5. The apparatus of claim 4, wherein the data stuffer reconstructs the dual transport stream by inserting the interleaved turbo stream into the portion of the dual transport stream from which the turbo stream was extracted as the specified data.

6. The apparatus of claim 5, wherein the outer interleaver interleaves bits of the encoded turbo stream according to an interleaving rule of {2, 1, 3, 0} to obtain the interleaved turbo stream.

7. The apparatus of claim 5, wherein the encoding performed by the outer encoder and the interleaving performed by the outer interleaver are part of a robust data process that enables the turbo stream of the dual transport stream to be transmitted without errors over an inferior channel over which the normal stream of the dual transport stream cannot be transmitted without errors.

8. The apparatus of claim 7, wherein the inferior channel is a Doppler fading channel.

9. The apparatus of claim 2, wherein the normal stream complies with an Advanced Television Systems Committee (ATSC) Vestigial Sideband (VSB) Digital Television (DTV) standard.

10. The apparatus of claim 1, wherein the data stream is an MPEG-2 transport stream.

11. The apparatus of claim 1, wherein the specified data process is a robust data process that enables the specified data to be transmitted with an error rate that is lower than an error rate when the specified data is transmitted without being subjected to the robust data process.

12. A method of processing data for a digital broadcast transmission, the method comprising:
receiving a data stream on which an interleaving process has been performed and extracting specified data from the data stream to obtain extracted data;
performing a specified data process on the extracted data to obtain processed data; and
reconstructing the data stream by inserting the processed data into a portion of the data stream from which the specified data was extracted.

13. The method of claim 12, wherein the data stream is a dual transport stream comprising a normal stream and a turbo stream.

14. The method of claim 13, wherein the extracting of the specified data comprises extracting the turbo stream from the dual transport stream as the specified data to obtain extracted data.

15. The method of claim 14, wherein the turbo stream comprises a parity insertion region; and
wherein the performing of a specified data process on the extracted data comprises:
encoding the turbo stream to obtain parity data and inserting the parity data into the parity insertion region of the turbo stream to obtain an encoded turbo stream; and
interleaving the encoded turbo stream to obtain an interleaved turbo stream.

16. The method of claim 15, wherein the reconstructing of the data stream comprises reconstructing the dual transport stream by inserting the interleaved turbo stream into the portion of the dual transport stream from which the turbo stream was extracted as the specified data.

17. The method of claim 15, wherein the interleaving of the encoded turbo stream comprises interleaving bits of the encoded turbo stream according to an interleaving rule of {2, 1, 3, 0} to obtain the interleaved turbo stream.

18. The method of claim 15, wherein the encoding of the turbo stream and the interleaving of the encoded turbo stream are part of a robust data process that enables the turbo stream of the dual transport stream to be transmitted without errors over an inferior channel over which the normal stream of the dual transport stream cannot be transmitted without errors.

19. The method of claim 18, wherein the inferior channel is a Doppler fading channel.

20. The method of claim 13, wherein the normal stream complies with an Advanced Television Systems Committee (ATSC) Vestigial Sideband (VSB) Digital Television (DTV) standard.

21. The method of claim 12, wherein the data stream is an MPEG-2 transport stream.

22. The method of claim 12, wherein the specified data process is a robust data process that enables the specified data to be transmitted with an error rate that is lower than an error rate when the specified data is transmitted without being subjected to the robust data process.
